(19) United States
(12) Patent Application Publication
(10) Pub. No.: US 2023/0300311 A1
(43) Pub. Date: Sep. 21, 2023

(54) LENS, THREE-DIMENSIONAL IMAGING MODULE, APPARATUS, METHOD, DEVICE AND STORAGE MEDIUM

(71) Applicant: GUANGDONG LAUNCA MEDICAL DEVICE TECH. CO., LTD., Guangdong (CN)

(72) Inventors: Jian LU, Dongguan (CN); Pan TANG, Dongguan (CN); Lei CHEN, Dongguan (CN)

(73) Assignee: GUANGDONG LAUNCA MEDICAL DEVICE TECH. CO., LTD., Dongguan (CN)

(21) Appl. No.: 18/010,270

(22) PCT Filed: Jun. 15, 2020
(86) PCT No.: PCT/CN2020/096040

§ 371 Date: Dec. 14, 2022

(51) Int. Cl. H04N 13/254; G02B 3/02; G06T 17/00; G06T 7/521; G06T 7/55; H04N 13/218

(52) U.S. Cl. CPC H04N 13/254; G02B 3/02; G06T 17/00; G06T 7/521; G06T 7/55; H04N 13/218; G06T 2210/56; G06T 2200/08; G06T 2207/10028; G06T 2207/10012

(57) ABSTRACT

Disclosed is a lens, comprising a lens element which comprises a first sub-lens and at least two second sub-lenses. The second sub-lens has a non-rotationally symmetrical structure, the first sub-lens comprises a first active clear portion, and the second sub-lens comprises a second active clear portion, wherein the second active clear portions of any two second sub-lenses are rotationally symmetrical with respect to an incident axis; the first active clear portion is configured for an incident beam to pass therethrough so as to form a first image on an image side of the lens; and the second active clear portion is configured for the incident beam to pass therethrough so as to form a second image on the image side of the lens, the number of second images being the same number as the number of second active clear portions, and the first image and each second image being spaced apart from each other.

### TECHNICAL FIELD

The present disclosure relates to the field of three-dimensional imaging technology, in particular to a lens, a three-dimensional imaging module, apparatus, method, and device, and a storage medium.

### BACKGROUND

Conventional three-dimensional scanning systems have been widely used in many fields, such as AR, unmanned aerial vehicles, robotics, industrial processes, medical apparatus, etc. In these conventional three-dimensional scanning systems, images of an object being photographed from different angles are generally collected through a plurality of lenses to form three-dimensional point cloud data, and then point cloud matching is performed by calculating the similarity of the point clouds at two adjacent scanning moments, i.e., the image data photographed at different locations while the lens are continuously moving are merged together to finally reconstruct a complete three-dimensional model of the object. However, due to the configuration of being provided with a plurality of lenses, this conventional three-dimensional scanning system has the problem of being difficult to perform three-dimensional scanning in narrow spaces due to its excessively large size SUMMARY

According to various embodiments of the present disclosure, a lens, a three-dimensional imaging module, apparatus, method, and device, and a storage medium are provided.

A lens having an incident axis includes a lens element. The lens element includes a first sub-lens and at least two second sub-lenses. The second sub-lens has a non-rotationally symmetric structure. The first sub-lens includes a first effective light passing portion. The second sub-lens includes a second effective light passing portion. The second effective light passing portions of any two of the second sub-lenses are rotationally symmetric relative to the incident axis.

The first effective light passing portion of the lens element is configured for the incident beam to pass therethrough to form a first image on an image side of the lens. The second effective light passing portions of the lens element are configured for the incident beam to pass therethrough to form second images on the image side of the lens, and the number of the second images is the same as the number of the second effective light passing portions. The first image and the second images are spaced apart from each other.

A three-dimensional imaging module includes an image sensor and a lens according to any one of the aforementioned embodiments. The image sensor is provided on the image side of the lens.

A three-dimensional imaging apparatus includes the three-dimensional imaging module of any one of the aforementioned embodiments.

A three-dimensional imaging method, applied to the lens of any one of the aforementioned embodiments. The three-dimensional imaging method includes the following steps:
acquiring a first image and second images of a same frame within a predetermined time, wherein the first image has two-dimensional surface information of an object being photographed;
acquiring, according to at least two of the second images of the same frame, a three-dimensional information image of this frame with three-dimensional point cloud information, and
determining, according to the first image and the three-dimensional information image of the same frame, a three-dimensional model of the object being photographed in this frame.

In the three-dimensional imaging method, the first image may be acquired through the first sub-lens in the aforementioned lens and the second images may be acquired through the second sub-lenses in the aforementioned lens.

A three-dimensional imaging device includes.
an acquiring module, configured to acquire a first image and second images of a same frame within a predetermined time, wherein the first image has two-dimensional surface information of an object;
a processing module, configured to obtain, according to at least two of the second images of the same frame, a three-dimensional information image of this frame with three-dimensional point cloud information, and
a determining module, configured to determine, according to the first image and the three-dimensional information image of the same frame, a three-dimensional model of the object being photographed in this frame.

A three-dimensional imaging apparatus includes:
a projector configured to project a first flash and a second flash to an object within a predetermined time;
a memory, configured to store a computer program.
a receiver, configured to acquire a first image according to the first flash and second images according to the second flash within a predetermined time, wherein the first image has two-dimensional surface information of the object being photographed; and
a processor, configured to execute the computer program on the memory to implement: obtaining a three-dimensional information image of this frame with three-dimensional point cloud information according to at least two of the second images of the same frame, and determining a three-dimensional model of the object being photographed in this frame according to the first image and the three-dimensional information image of the same frame.

A storage medium on which a computer program is stored is provided. The computer program implements the steps of the method in any one of the aforementioned embodiments when executed by a processor.

Details of one or more embodiments of the present disclosure are presented in the accompanying drawings and descriptions below. Other features, objects and advantages of the present disclosure will become apparent from the specification, the accompanying drawings, and the claims.

### BRIEF DESCRIPTION OF THE DRAWINGS

In order to better describe and illustrate those embodiments and/or examples of the invention disclosed herein, reference may be made to one or more of the accompanying drawings. Additional details or examples used to describe the accompanying drawings should not be considered as limiting the scope of any of the disclosed inventions, the embodiments and/or examples presently described, and the best mode of these inventions as presently understood.

FIG. 1 is a schematic diagram of a three-dimensional imaging module containing a lens according to an embodiment of the present disclosure.

FIG. 2 is a schematic diagram of a part of the structure of the lens of FIG. 1.

FIG. 3 is a schematic distribution diagram of imaging images corresponding to the lens of FIG. 2.

FIG. 4 is a schematic diagram of a three-dimensional imaging module containing a lens according to another embodiment of the present disclosure.

FIG. 5 is a schematic diagram of a part of the structure of the lens according to another embodiment of the present disclosure.

FIG. 6 is a schematic distribution diagram of imaging images corresponding to the lens of FIG. 5.

FIG. 7 is a schematic diagram of a part of the structure of the lens according to another embodiment of the present disclosure.

FIG. 8 is a schematic diagram of a part of the structure of the lens according to another embodiment of the present disclosure.

FIG. 9 is a schematic distribution diagram of imaging images corresponding to the lens of FIG. 8.

FIG. 10 is a schematic diagram of a three-dimensional imaging module containing a lens according to another embodiment of the present disclosure.

FIG. 11 is a schematic diagram of a part of the structure of a three-dimensional imaging apparatus provided in an embodiment of the present disclosure.

FIG. 12 is a flow diagram of a three-dimensional imaging method provided in an embodiment of the present disclosure.

FIG. 13 is a flow diagram of a three-dimensional imaging method provided in another embodiment of the present disclosure.

FIG. 14 is a flow diagram of the merging of the three-dimensional information images in the three-dimensional imaging method provided in an embodiment of the present disclosure.

FIG. 15 is a flow diagram of the merging of the first images in the three-dimensional imaging method provided in an embodiment of the present disclosure.

FIG. 16 is a block diagram of a three-dimensional imaging device provided in an embodiment of the present disclosure.

FIG. 17 is a block diagram of a three-dimensional imaging device provided in another embodiment of the present disclosure.

FIG. 18 is an internal structure diagram of a three-dimensional imaging apparatus provided in an embodiment of the present disclosure.

### DETAILED DESCRIPTION OF THE EMBODIMENTS

In order to facilitate the understanding of the present disclosure, the present disclosure will be more fully described below with reference to the relevant accompanying drawings. Preferred embodiments of the present disclosure are given in the accompanying drawings. However, the present disclosure can be implemented in many different forms and is not limited to the embodiments described herein. Rather, these embodiments are provided for the purpose of providing a more thorough and comprehensive understanding of the disclosure of the present disclosure.

It is noted that when an element is described to be “fixed” to another element, it may be directly fixed on the other element or an intermediate element may exist. When an element is considered to be “attached” to another element, it can be directly attached to the other element or an intermediate element may exist. The terms “inside”, “outside”, “left”, “right” and similar expressions used herein are for illustrative purposes only, and are not meant to be the only means of implementation.

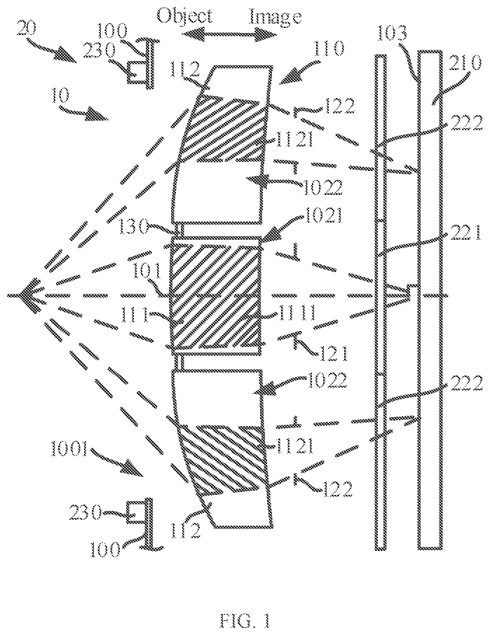

Referring to FIG. 1, some embodiments of the present disclosure provide a three-dimensional imaging module 20, the three-dimensional imaging module includes a lens 10 and an image sensor 210. The image sensor 210 is provided on an image side of the lens 10. The image sensor 210 may be a CCD (Charge Coupled Device) or a CMOS (Complementary Metal Oxide Semiconductor) element. An imaging surface 103 of the lens 10 overlaps with a light-sensitive surface of the image sensor 210.

The lens 10 has a positive focal power, and the lens 10 is configured to converge image information of an object being photographed onto the imaging surface 103 to form an imaging image. The lens 10 includes a lens barrel 100 and a lens element 110 having a special-shaped structure. The lens element 110 is installed in the lens barrel 100, and an object end of the lens barrel 100 is provided with a light inlet aperture 1001. A central axis of the inlet aperture 1001 is co-linear with an incident axis 101 of the lens 10, or a small deviation may exist therebetween. The incident axis 101 is a virtual reference axis. The light inlet aperture 1001 in some embodiments may have a shape of oval, rectangle, and so on. The incident axis 101 of the lens 10 should be perpendicular to the light-sensitive surface and pass through a center of the light-sensitive surface. A light beam from the object being photographed, after being converged by the lens 10, is capable of forming a corresponding number of imaging images on the light-sensitive surface of the image sensor 210. In particular, when the number of the image sensors 210 is one, each of the imaging images can be formed on this one image sensor 210, such that a lateral size of the module can be effectively controlled and a small size design of the three-dimensional imaging module 20 can be further realized.

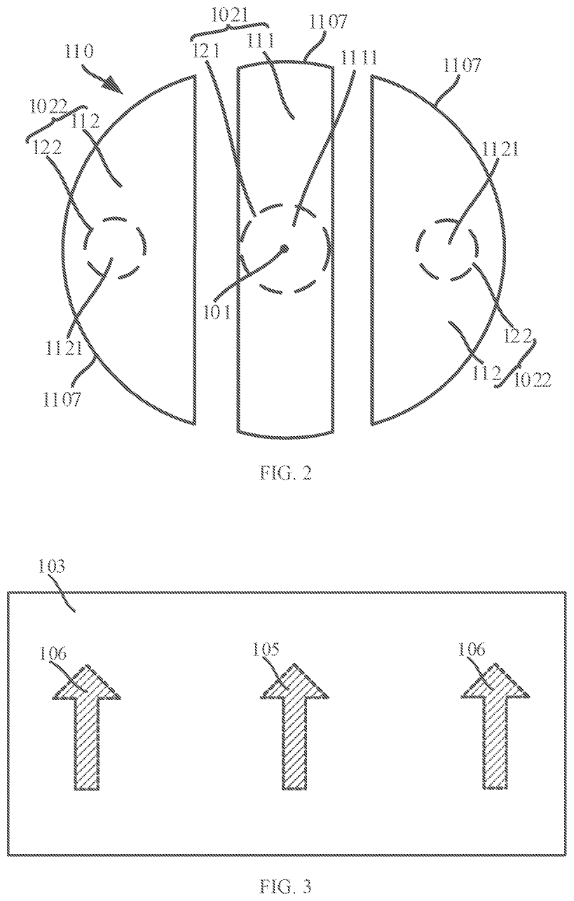

Referring to FIGS. 1 and 2, in the embodiments shown in FIGS. 1 and 2, the lens element includes a first sub-lens 111 and two second sub-lenses 112. The first sub-lens 111 and the two second sub-lenses 112 are spaced apart from each other in a direction perpendicular to the incident axis 101, and object side surfaces of both the first sub-lens 111 and the second sub-lens 112 are facing toward the inlet aperture. The second sub-lens 112 has a non-rotationally symmetric structure. The second sub-lens 112 has a non-rotationally symmetric structure means that, it has no such a symmetry axis in a direction parallel to the incident axis 101 that, around this symmetry axis the second sub-lens 112 can be rotated by an angle of θ (0<θ<360°) and still coincide with the state when it is not rotated.

The incident axis 101 passes through the first sub-lens 111, and the first sub-lens 111 is central symmetric relative to the incident axis 101. The two second sub-lenses 112 are provided on opposite sides of the first sub-lens 111 in a direction perpendicular to the incident axis 101, and the two second sub-lenses 112 are central symmetric relative to the incident axis 101, i.e., one of the second sub-lenses 112, after rotating 180° around the incident axis 101, is capable to coincide with the other of the second sub-lens 112, or a small deviation may exist therebetween. The two second sub-lenses 112 which are central symmetric are structurally identical, e.g. the two second sub-lenses 112 have the same face shape on the object side and the same face shape on the image side. In particular, in this embodiment, the first sub-lens 111 and the two second sub-lenses 112 may be made by slicing one same lens, i.e., the first sub-lens 111 and the two second sub-lenses 112 are capable of being spliced together structurally to form one lens that is rotationally symmetric relative to the optical axis. Specifically, when the first sub-lens 111 and the second sub-lenses 112 are sliced from one lens, the slicing paths of the lens are parallel to the optical axis of the lens, and when sliced and installed in the lens barrel, the slicing surfaces of the first sub-lens 111 and the second sub-lenses 112 formed by the slicing are flat and remain parallel to each other. The sliced first sub-lens 111 and second sub-lenses 112 are spaced apart along a direction perpendicular to the optical axis of the lens. The object side of the aforementioned lens may be spherical or aspherical, and the image side thereof may be spherical or aspherical.

In this embodiment, the first sub-lens 111 and the second sub-lenses 112 are each include an arcuate edge 1107. The arcuate edges 1107 of the first sub-lens 111 and the second sub-lenses 112 are farther away from the incident axis 101 relative to their own structures. If the aforementioned first sub-lens 111 and second sub-lenses 112 are spliced together to form a complete lens, the arcuate edges 1107 of the two sub-lenses will serve as the edges of the maximum effective light passing region of the object side or the image side of the lens. It is to be noted that a general lens actually further includes a clamping portion, which is a non-light passing portion, but the descriptions of the first sub-lens 111, the second sub-lenses 112 and the various symmetrical relationships of the lens in the present disclosure does not involve the clamping portion.

With further reference to FIG. 3, the first sub-lens 111 includes a first effective light passing portion 1111, and each of the second sub-lenses 112 includes a second effective light passing portion 1121, respectively. The first effective light passing portion 1111 of the first sub-lens 111 is configured for an incident beam to pass therethrough to form a first image 105 on the image side of the lens 10. Similarly, the second effective light passing portion 112 in each of the second sub-lenses 112 is configured for the incident beam to pass therethrough to form at least two second images 106 on the image side of the lens 10, and the number of the at least two second images 106 is the same as the number of the second effective light passing portions 1121 of the lens element, and the at least two second images 106 are separated from each other. That is, the incident beam, after being converged by each of the second effective light passing portions 1121, is capable of forming a second image 106. It is noted that the first image 105 formed by the first sub-lens 111 and the second images 106 formed by the second sub-lenses 112 are spaced apart from each other and do not overlap with each other. In some embodiments, the first effective light passing portion 1111 and the second effective light passing portions 1121 in one same lens element 110 are spaced apart from each other. The region of the first sub-lens 111 through which the incident beam forming the first image 105 passes is the first effective light passing portion 1111, and the region of the second sub-lens 112 through which the incident beam forming the second image 106 passes is the second effective light passing portion 1121. In the embodiment of the present disclosure, any two second effective light passing portions 1121 should be rotationally symmetrical relative to the incident axis 101 as far as possible to ensure that the second images 106 formed are imaged in a view that is symmetrical relative to the object being photographed, thereby facilitating the acquisition of accurate three-dimensional data of the surface of the object being photographed through the second images 106. The rotationally symmetric relationship in the present disclosure includes, but is not limited to, that one part is capable to coincide with another part after rotating 90°, 135° 180°, 225° etc. about the rotationally symmetry axis.

The aforementioned first sub-lens 111 and the second sub-lenses 112 are spaced apart from each other, such that the imaging images (the first image 105 and the second images 106) on the imaging surface 103 can be spaced apart from each other, thereby enabling three-dimensional analysis on the corresponding features in each of the imaging images at the system terminal.

The light-sensitive surface on the image sensor 210 generally has a shape of rectangle, and in the embodiment of FIG. 1, the spacing direction of the two second sub-lenses 112 is parallel to a length direction of the light-sensitive surface, and the spacing distance between the second sub-lenses 112 along a direction parallel to the length direction is greater than or equal to half of the length of the light-sensitive surface, thereby facilitating the formation of two spaced imaging images on the light-sensitive surface. The aforementioned spacing distance between the sub-lenses can be understood as the minimum distance between the two sub-lenses along the direction parallel to the length direction. Further, the spacing distance between the two second sub-lenses 112 along the direction parallel to the length direction should be less than or equal to three-fourths of the length of the light-sensitive surface, thus preventing the problem of degradation of the imaging quality caused by too skewed imaging images resulted from too large spacing distance between the second sub-lenses 112.

In all, by using the aforementioned lens 10, the lateral size of the three-dimensional imaging module 20 can be effectively reduced, so as to expand the use space of the module, such that the three-dimensional imaging module 20 can achieve more efficient and flexible three-dimensional imaging in narrow space. It should be noted that instead of providing only one image sensor 210, two or more image sensors 210 may also be provided in the three-dimensional imaging module 20, and each of the image sensors 210 corresponds to one or two imaging images.

Referring to FIGS. 2 and 3, when the lens element 110 in the lens 10 is a complete lens, the object being photographed, after being converged by the lens is capable of forming an original imaging image on the imaging surface 103 of the lens 10. As the lens is sliced into a first sub-lens 111 and two second sub-lenses 112 along a direction perpendicular to the incident axis 101, and the first sub-lens 111 and the two second sub-lenses 112 are spaced apart from each other, the incident light beam, after passing through each of the sub-lenses, will correspondingly form a new imaging image on the imaging surface 103, respectively. That is, the original imaging image on the imaging surface 103 will be gradually separated into three new imaging images as the spacing distances between the sub-lenses increase. The spacing direction between the imaging images depends in part on the spacing direction between the sub-lenses. When the spacing distances between the sub-lenses are large enough, the three new imaging images will be completely spaced apart from each other without overlapping with each other. At this time, depths, heights and other three-dimensional information of the corresponding features can be obtained after terminal analysis on the depressions, bumps and other features in the two spaced second images 106, and the terminal analysis method includes but is not limited to a binocular ranging method, or comparing the two second images 106 by a cross-correlation or least square method, or other methods to obtain the three-dimensional point cloud of the object being photographed.

Taking the binocular ranging method as an example, for a feature structure of a depression or a bump on the object being photographed, the corresponding imaging of the depression and the bump in the imaging image will have different degrees of dispersion, and the first imaging unit 1021 and the second imaging unit 1022 which are spaced apart, can image the feature structure from different angles, such that the lens 10 also can achieve the effect of binocular vision. By perform terminal analysis on the same feature on the two second images 106, such as the dispersion of the feature imaging and/or the spacing distance of the feature imaging in the two images, the depth information of the feature structure can be derived. By using the lens 10 in the aforementioned embodiment, the three-dimensional information of the surface of the object can be reconstructed by using the two-dimensional imaging information of the object being photographed, thereby enabling three-dimensional imaging for the surface of the object being photographed.

In another aspect, colored first image 105 can be obtained through the first sub-lens 111, and the colored first image 105 is an image carrying two-dimensional information. Three-dimensional information images obtained by the second sub-lenses 112 can then be superimposed on the two-dimensional image to obtain a more accurate and comprehensive three-dimensional imaging. Further, when the three-dimensional imaging system with the aforementioned lens 10 needs to perform continuous moving scanning, the system can match three-dimensional point clouds in second images at two adjacent scanning moments by performing Iterative Closest Point (ICP) processing on the information of the three-dimensional point clouds in the imaging images at the two adjacent scanning moments, and then merge the imaging images of the adjacent regions together. At the same time, the system can perform Scale-Invariant Feature Transform (SIFT), Speeded Up Robust Features (SURF), and other feature algorithms on the first images 105 carrying two-dimensional information acquired at the two adjacent scanning moments to merge the imaging images at the two adjacent scanning moments together. In this way, the three-dimensional imaging system can merge the two-dimensional information images at the two adjacent scanning moments by performing feature matching on the two-dimensional information images (e.g. colored images) at the two adjacent scanning moments; at the same time, the three-dimensional imaging system can merge the three-dimensional information images (e.g. three-dimensional point clouds) at the two adjacent scanning moments by performing iterative closest point process on the three-dimensional information images at the two adjacent scanning moments. With the joint action of the two merging methods, the merging accuracy between the images obtained by the system during continuous movement can be effectively improved, such that a continuous and complete three-dimensional model can be reconstructed.

In the design of the aforementioned embodiment, it is only necessary to configure the sub-lenses in the lens 10 to be spaced apart at a distance along a direction perpendicular to the incident axis 101 to space the two new imaging images apart, such that two imaging images of the object being photographed from different angles can be obtained through one lens 10. Compared with the design of two or even more lenses 10, the aforementioned single lens 10 design can greatly reduce the lateral size of the three-dimensional imaging system, and therefore also facilitate the reduction of the size of the fixing structure used to install the lens 10 in the three-dimensional imaging apparatus, such that the apparatus can better perform three-dimensional imaging in narrow spaces. For example, when the lens 10 is installed in a probe of an endoscope, a size of the probe can be effectively reduced because only one lens 10 is required to achieve three-dimensional information acquisition, thereby increasing the operational flexibility of the probe in a confined space.

In the embodiment shown in FIG. 1, each first sub-lens 111 can form one first imaging unit 1021, and each first imaging unit 1021 corresponds to one first image 105. That is, the incident light beam, after being adjusted by the first imaging unit 1021, is capable of forming a first image 105 on the imaging surface 103 of the lens 10. Each second sub-lens 112 can form one second imaging unit 1022, and each second imaging unit 1022 corresponds to one second image 106. That is, the incident beam, after being adjusted by the second imaging unit 1022, is capable of forming a second image 106 on the imaging surface 103 of the lens 10. The incident beam is adjusted by each of the imaging units to be able to form a corresponding number of imaging images on the image side.

In some embodiments, the lens 10 includes apertures, the number of the apertures is the same as the number of the sub-lenses in the lens element 110, and the sub-lenses (the first sub-lens 111 and the second sub-lenses 112) in the lens element 110 are in a one-to-one correspondence with the apertures in a direction parallel to the incident axis 101. The aperture corresponding to the first sub-lens 111 is a first aperture 121 and the aperture corresponding to the second sub-lens 112 is a second aperture 122. A first sub-lens 111 and a first aperture 121 in correspondence with each other form a first imaging unit 1021, and a second sub-lens 112 and a second aperture 122 in correspondence with each other form a second imaging unit 1022. In the embodiment of the present disclosure, the sub-lens and the aperture in any imaging unit are arranged along a direction parallel to the incident axis 101. In a direction parallel to the incident axis 101, an overlap exists between the projection of each of the sub-lenses and the projection of the corresponding aperture of a same imaging unit on the imaging surface 103. The incident beam, after being adjusted by each imaging unit, is capable of forming a corresponding imaging image on the imaging surface 103. The aperture in each imaging unit can be configured to control a depth of field and a brightness of the image, and the aperture diameter of the aperture can be fixed or adjustable.

Further, the second aperture 122 of each of the second imaging units 1022 should be central symmetric relative to the incident axis 101 of the lens 10 as far as possible, and the aperture diameters of the second apertures 122 should be the same, so as to ensure that the brightness of the second images 106 formed by the second imaging units 1022 tends to be the same, which in turn facilitates the accuracy of the three-dimensional information obtained by each of the second images 106. The aperture can further be configured to limit the edge beam to suppress spherical aberrations introduced by the edge beam, and control the depth of field of the imaging image. In some embodiments, the apertures are relatively independent of the lens barrel 100 in the lens 10, and at this time, the apertures can be assembled together with the lens element 110 when the lens element 110 is installed into the lens barrel 100.

In the embodiment of FIG. 1, the first aperture 121 is disposed on the image side of the first sub-lens 111, and the second aperture 122 is disposed on the image side of the second sub-lens 112. The line connecting the center of the first aperture 121 and the center of the second aperture 122 is perpendicular to the incident axis 101. In a direction parallel to the incident axis 101, an overlap exist between the projection of the first sub-lens 111 and the projection of the first aperture 121 on the imaging surface 103, and an overlap exist between the projection of the second sub-lens 112 and the projection of the second aperture 122 on the imaging surface 103. In some other embodiments, the first aperture 121 may be disposed on the object side of the first sub-lens 111, and the second apertures 122 may also be disposed on the object side of the second sub-lenses 112. The line connecting the center of the first sub-lens 111 and the center of the second sub-lens 112 remains perpendicular to the incident axis 101. The configuration of being symmetrical relative to the incident axis 101 of each sub-lens and each aperture is conducive to improving the consistency of the brightness, sharpness, and size of the imaging images, which in turn is beneficial to the accuracy of the terminal analysis.

It should be noted that, since each of the second imaging units 1022 is mainly used to acquire three-dimensional information, the aperture diameters of the second apertures 122 should be the same, so as to ensure that the brightness and the depth of field of the second images 106 tends to be the same, thereby improving the accuracy of the terminal analysis and processing. The first imaging unit 1021 is mainly used to acquire two-dimensional colored imaging, therefore the aperture diameter of the first aperture 121 in some embodiments can be larger than the aperture diameter of the second aperture 122, so as to improve the brightness of the first image 105, and ensure the sharpness of the two-dimensional colored imaging. In all, since the types of imaging images obtained by the first imaging unit 1021 and the second imaging unit 1022 are independent of each other, in some embodiments, the structure of the first effective light passing portion 1111 in the first sub-lens 111 may be different from, but may also be the same as, the structure of the second effective light passing portion 1121 in the second sub-lens 112.

It should be noted that, in some embodiments, each of the sub-lenses in the lens element 110 is coated with a light-shielding film, the light-shielding film is disposed on the object side and/or the image side of the sub-lens, and a light passing region is retained in each of the light-shielding films, respectively. The light-shielding film may have an aperture effect, and the size of the light passing region can be regarded as the size of the aperture diameter of the aperture.

Further, in order to prevent incident light beams beyond the first sub-lens 11l and the second sub-lens 112 from reaching the image sensor 210, in some embodiments, the lens 10 further includes a light-shielding board 130. The light-shielding board 130 is connected between the respective sub-lenses in the lens element 110, and the light-shielding board 130 is light tight. The light-shielding board 130 may be a metal plate or a plastic plate, and the light-shielding board 130 may be arranged perpendicular to the incident axis 101. The light-shielding board 130 may be provided with a black coating to prevent the incident beam from being reflected by the light-shielding board 130 to form stray light in the lens 10. By connecting each sub-lens, the light-shielding board 130 can also serve to increase the installation stability between the sub-lenses.

Further, in some embodiments, in order to avoid interference light from reaching the imaging surface 103, the three-dimensional imaging module 20 further includes a filter. The filter is disposed between the lens 10 and the image sensor 210, or it can also be disposed on the object side of the lens 10, such as disposed covering the inlet aperture 1001 in the lens barrel 100. For different wavelengths of working light, the filter includes at least one of a visible bandpass filter, an infrared bandpass filter, and an infrared cutoff filter. In some embodiments, the three-dimensional imaging module 20 includes a first filter 221 and at least two second filters 222, an overlap exists between the projection of the first filter 221 and the projection of the first sub-lens 111 in the lens element 110 on a plane perpendicular to the incident axis 101. An overlap exists between the projection of each of the second sub-lenses 112 in the lens element 110 and the projection of one of the second filters 222 on a plane perpendicular to the incident axis 101. The first filter 221 and the second filter 222 are configured to filter out different wavelengths of light. In one embodiment, for example, when the first imaging unit 1021 is configured to converge incident light in the visible band to form a colored imaging, the first filter 221 is an infrared cutoff filter to filter out infrared light. When the second imaging unit 1022 is configured to converge incident light in the infrared band to form an infrared imaging, the second filter 222 is an infrared bandpass filter to filter out light outside the desired band. In some other embodiments, the second image 106 can also be formed by convergence of visible light at a particular wavelength, which can be, for example, 587.56 nm, or 555 nm. At this time, the corresponding second filter 222 should be a bandpass filter for the corresponding wavelength band. The relationships of filtering light of the first filter 221 and the second filter 222 can be varied and is not limited to the aforementioned solutions, as long as the light that interferes with the first image 105 and the second image 106 can be eliminated.

In some embodiments, the first filter 221 and the second filters 222 form as an integral structure, so as to reduce the alignment requirements and processing complexity of the filters in the module by reducing the number of filters. The first filter 221 and the second filters 222 may also be spaced apart with each other. The specific arrangement relationships of the first filter 221 and the second filters 222 can be determined according to the actual design requirements.

In another aspect, in some embodiments, when the second image 106 is formed by the convergence of a specific wavelength band of light, a light source 230 can be additionally disposed in the three-dimensional imaging module 20 to irradiate the corresponding wavelength band of light on the object being photographed. The light source 230 is fixed relative to the lens 10. For example, when the specific wavelength band is 900 nm infrared light, the second filter 222 can be selected as a 900 nm narrow bandpass filter, so as to filter out the incident light beam other than 900 nm wavelength to avoid interference to the second image 106. Of course, it is also possible to select a light source 230 capable of emitting light at 587.56 nm, 555 nm, etc., and at this time, the second filter 222 should be configured as a bandpass filter for the corresponding wavelength band. In some other embodiments, a filter film, instead of the filter, may be disposed on the object side and/or the image side of the second sub-lens 112 to achieve the filtering effect. The wavelengths of light emitted by the light source 230 and the wavelengths corresponding to the filters described above are only a few specific examples, and the wavelengths corresponding to the light source 230 and the filters in the actual product will depend on the demand, and will not be repeated here.

In some embodiments, the three-dimensional scanning system can first obtain the first image 105, at this time, by using the light source 230 to emit white light to irradiate the object being photographed, the three-dimensional imaging module 20 can obtain the colored first image 105 reflected back. Of course, when the three-dimensional imaging is performed under sufficient ambient light, the light source 230 capable of emitting white light can also be omitted. Subsequently, the light source 230 irradiates the object being photographed with a specific wavelength of light to enable the three-dimensional imaging module 20 to acquire the corresponding second images 106, and the irradiation of monochromatic light can improve the accuracy of analysis on each of the second images 106 by system to acquire a three-dimensional point cloud. In some embodiments, the time interval between the acquisition of the first image 105 and the acquisition of the second images 106 is less than 1 ms, and each imaging time (exposure time) is less than or equal to 100 ms, whereby the first image 105 and the second image 106 can be considered as being acquired at the same moment, and can be considered as imaging acquired from the same region of the object being photographed at the same moment. In some other embodiments, the three-dimensional scanning system may also acquire the first image 105 and the second image 106 at the same time.

Further, in some embodiments, when the problematic features of the surface of the object being photographed are considerably lacking, a projection element may be provided in the three-dimensional imaging module 20 to project special optical patterns onto the surface of the object being photographed, thereby improving the contrast of the surface of object being photographed and increasing the detection sensitivity. The optical patterns include, but are not limited to, stripes, light spots, grids, etc.

In another aspect, the configurations of each of the second sub-lenses 112 and each of the apertures in the present disclosure is not limited to the solutions mentioned in the above embodiments. Referring to FIG. 4, in some embodiments, the axial direction of each of the second sub-lenses 112 is inclined to the incident axis 101. For each of the second sub-lenses 112 inclined disposed, the object side of the second sub-lens 112 is closer to the incident axis 101 than the image side thereof. In some embodiments, the angle between the axial direction of the second sub-lens 112 and the incident axis 101 of the lens 10 is 1° to 20°. The inclined disposed second sub-lens 112 can increase the spacing distance between the second images 106, i.e., a spacing relationship between the corresponding imaging images can be formed by using a smaller spacing distance between the second sub-lenses 112, thus facilitating further reduction of the lateral size of the lens 10. In addition, by controlling the inclined angle, it is also beneficial to avoid that the spacing distance between the imaging images is too large and the region where feature information exists on each imaging image is beyond the imaging range of the image sensor 210. Similarly, in some embodiments, the second aperture 122 corresponding to the second sub-lens 112 is also inclined in synchronization with the corresponding second sub-lens 112, and the central axis of the second aperture 122 that is also inclined disposed is parallel to the axial direction of the corresponding sub-lens, so as to ensure the consistency of the brightness throughout the second image 106. The aforementioned inclined disposed configuration of each of the second sub-lenses 112 and the second apertures 122 can also be understood as the overall inclined disposed configuration of the corresponding second imaging unit 1022, and each of the second imaging units 1022 should also be rotationally symmetric relative to the incident axis 101 in addition to being inclined disposed relative to the incident axis 101. It should be noted that in some embodiments, the axial direction of the second sub-lens 112 can be understood as, when the axial direction of each of the second sub-lenses 112 in the same lens element is parallel to the central axis of the first sub-lens 111, at this time, the second sub-lens 112 can be spliced together with the first sub-lens 111 as a complete lens by translating each of the second sub-lenses 112.

In another aspect, the specific arrangement positions of the apertures can be varied and are not limited to the configuration solution shown in FIG. 1. In some embodiments, the line connecting the centers of the two second apertures 122 is parallel to the direction of the line connecting the centers of gravity of the two second sub-lenses 112. In some other embodiments, the line connecting the centers of the two apertures is inclined to the line connecting the centers of gravity of the two sub-lenses. Depending on the positions of the apertures, the positions of the corresponding imaging images may also be changed. For example, the spacing direction between the two second sub-lenses 112 is parallel to the length direction of the light-sensitive surface. At this time, the direction of the line connecting the centers of the apertures is inclined to the direction of the line connecting the centers of gravity of the two second sub-lenses 112, the two second images 106 will not only be spaced in the length direction of the light-sensitive surface, but also have a spacing component in the direction inclined to the length direction. That is, the two second images 106 will be spaced along the diagonal direction of the light-sensitive surface, thus improving the utilization of the light-sensitive surface.

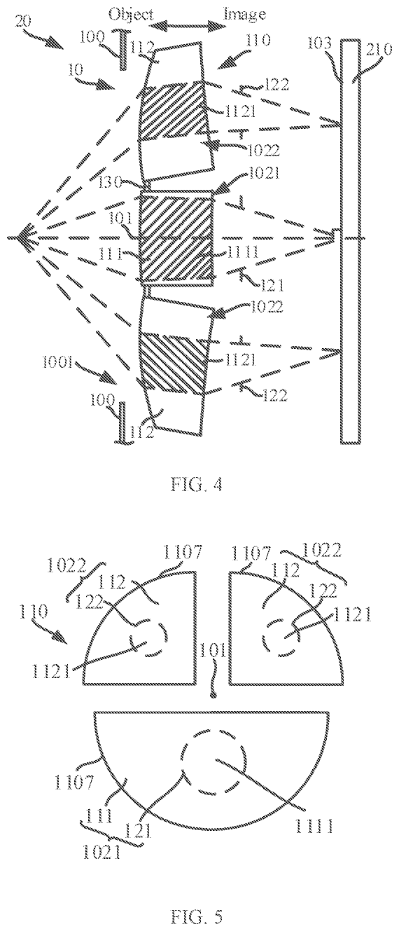

In the embodiment shown in FIG. 5, instead of arranging the two second imaging units 1022 on opposite sides of the first imaging unit 1021, it is also possible to arrange the two second imaging units 1022 on the same side of the first imaging unit 1021, and at this time, the first imaging unit 1021 and the two second imaging units 1022 are arranged around the incident axis 101, but the two second imaging units 1022 are still rotationally symmetric relative to the incident axis 101.

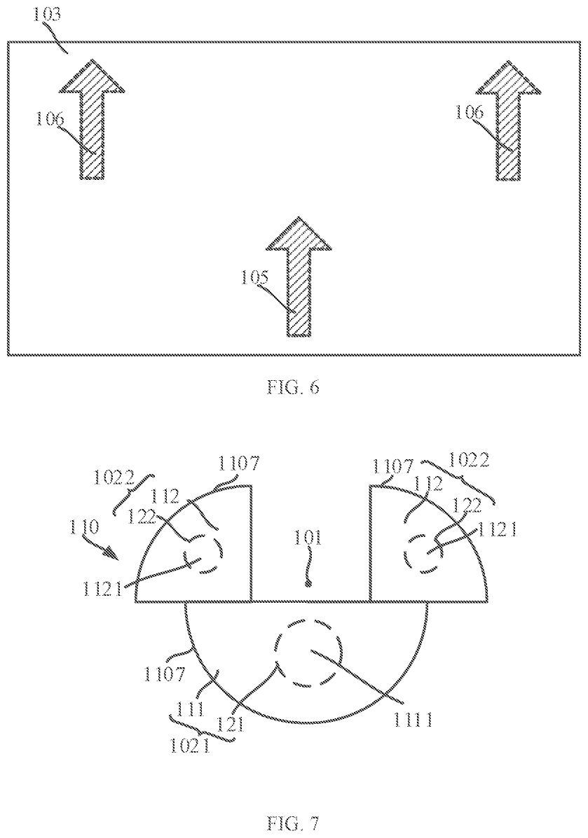

Referring to FIG. 6, for the arrangement of the first sub-lens 111 and the second sub-lenses 112 in the embodiment of FIG. 5, the arrangement of the first image 105 and the second images 106 also differs depending on the positions of the first imaging unit 1021 and the second imaging units 1022. Instead of the arrangement of the imaging units shown in the aforementioned embodiments, the first imaging unit 1021 and the second imaging units 1022 may also be arranged in other manners, and the arrangement of the corresponding first image 105 and second images 106 will be different accordingly, more specific arrangements will not be described here.

Instead of the spaced arrangement, the sub-lenses in the lens 10 element can also be arranged in a staggered arrangement to obtain spaced imaging images. Referring to FIG. 7, in some embodiments, the first sub-lens 111 and the two second sub-lenses 112 that can be spliced together to form a complete lens are arranged in a staggered manner in a direction perpendicular to the incident axis 101, and the two second sub-lenses and the first sub-lens 111 in the staggered arrangement are kept in abutment with each other. When the two second sub-lenses 112 are translated in the staggered direction, they can be spliced together with the first sub-lens to form a complete lens. The arrangement of the imaging images corresponding to the configuration of each of the sub-lenses in this embodiment can be referred to FIG. 6. By the staggered configuration, the spacing distance between the two second images 106 will increase as the staggering distance between the two second sub-lenses 112 increases, and the separating direction of the respective imaging images depends partly on the staggering direction of the two sub-lenses, and additionally on the arrangement positions of the second apertures 122.

Further, the spacing direction and the spacing distance between the imaging images also depends on the position relationship between the aperture and the sub-lens. In some embodiments, a spacing distance exist between the second apertures 122 in the two second imaging units 1022 in the direction perpendicular to the incident axis 101, and the size of the spacing distance will directly affect the spacing distance between the two second images 106 in that direction.

By realizing a spaced and staggered design for the sub-lenses in the lens element 110 and by adjusting the arrangement positions of the apertures, it is possible to obtain the imaging images in the expected arrangement and spacing relationship in a flexible manner. In addition, the arrangement relationship between the sub-lenses and the arrangement relationship between the apertures are not limited to the descriptions of the aforementioned embodiments, and any variations that can obtain the desired images by the aforementioned configuration principle shall be included in the scope of the present disclosure.

Further, instead of the two shown in the aforementioned embodiment, the number of the second sub-lenses 112 in the lens element 110 may be three, four or more, but the second effective light passing portions 1121 in any two second sub-lenses 112 should be rotationally symmetric relative to the incident axis 101. At this time, the sub-lenses are still disposed in one lens barrel, and the sub-lenses can also be sliced from one lens, and the sliced second sub-lenses 112 are non-rotationally symmetric. Compared to a plurality of lenses 10 each have a complete lenses, each of the sub-lenses in the aforementioned design has a smaller radial dimension than the complete lens, thereby allowing for installation into a single lens 10, reducing the lateral dimension of the module, and also allowing for the formation of separated imaging images after the incident light beam passes through the aforementioned sub-lenses.

Specifically, referring to FIG. 8, in some embodiments, the lens element 110 includes a first sub-lens 111 and three second sub-lenses 112. The shapes of the projections of the first sub-lens 111 and the second sub-lenses 112 on the imaging surface 103 along the direction parallel to the incident axis 101 are fan-shaped. The four sub-lenses are spaced apart from each other, and the four sub-lenses are rotationally symmetric relative to the incident axis 101 of the lens 10. As above, the four sub-lenses can be spliced together to form a complete lens when they are moved close to the incident axis 101. Specifically, a complete lens may be equally sliced into four sub-lenses with the slicing paths passing through and parallel to the central axis of the lens. The four sub-lenses are then translated along the radial direction of the original lens by a same distance. The four sub-lenses that are moved and held by the lens barrel 100 belong to a lens element 110 that is rotationally symmetric relative to the incident axis 101. In some embodiments, the aperture diameter of the first aperture 121 may be the same as or may also be different from the aperture diameter of the second aperture 122. The aforementioned contents shows the case of three second imaging units 1022, in some other embodiments, four, five or more second sub-lenses 112 can be provided in the lens element. In addition, the structural relationship between the first sub-lens 111 and the second sub-lenses 112 in some embodiments is not limited to the aforementioned description, and any configurations that can be simply deduced from the aforementioned principles shall be considered as within the scope of the present disclosure and will not be repeated here.

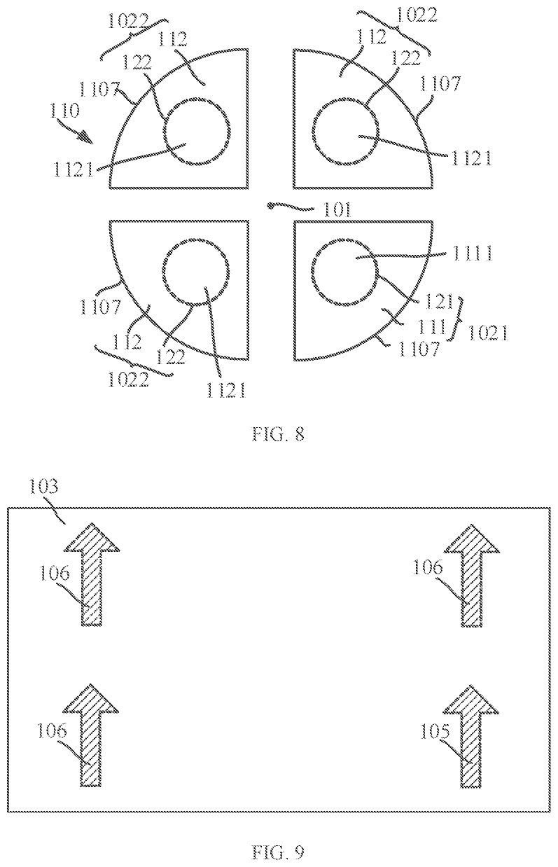

Referring to FIG. 9, in the embodiment shown in FIG. 8, four imaging units (one first imaging unit 1021 and three second imaging units 1022) are arranged around the incident axis 101, and the effective light passing portions in any two imaging units are rotationally symmetric relative to the incident axis 101, such that the corresponding four imaging images (one first image 105 and three second images 106) will also be arranged around the center of the imaging surface 103 accordingly and be spaced apart from each other.

The aforementioned embodiments are mainly described around the case that one lens element 110 is provided in the lens 10. Further, however, instead of having one lens element 110, the lens 10 in some embodiments may also be provided with at least two lens elements 110. The number of the lens elements 110 in the lens 10 may be two, three, four, five, or more, with the lens elements 110 arranged sequentially along the direction of the incident axis 101. In these embodiments, the lens 10 still includes a lens barrel 100 and the lens elements 110 are provided within the lens barrel 100. In some embodiments, the first sub-lens 111 and the second sub-lenses 112 in a lens element can be formed by slicing a complete lens. Different lens elements may be formed by slicing lenses with different structures. For a lens 10 having two or more lens elements 110, the structure of the lens 10 may be considered to be equally sliced from a lens group that can be practically applied in the product. The lens group includes but is not limited to a telephoto lens group, a wide-angle lens group, a macro lens group, etc. It is to be noted that, instead of being sliced from one lens, each first sub-lens 111 and each second sub-lens 112 may also be formed separately.

In an embodiment of the present disclosure, the number of the first sub-lenses 111 in each lens element 110 is the same and the number of the second sub-lenses 112 in each lens element 110 is the same. For example, each lens element 110 includes one first sub-lens 111 and two second sub-lenses 112. The first sub-lens 111 in a lens element 110 forms a correspondence with the first sub-lenses 111 in the other lens elements 110. Each group of the first sub-lenses 111 in correspondence with each other forms one first imaging unit 1021. The first imaging unit 1021 in some embodiments further includes a first aperture 121. Each of the second sub-lenses 112 in a lens element 110 forms a correspondence with each of the second sub-lenses 112 in the other lens elements 110. Each group of the second sub-lenses 112 in correspondence with each other forms one second imaging unit 1022. The second imaging unit 1022 in some embodiments further includes a second aperture 122. An overlap exists between projections of the sub-lenses in the same imaging unit on the imaging surface 103 in a direction parallel to the incident axis 101. In particular, in some embodiments, any two adjacent sub-lenses in any imaging unit can be spaced apart from each other, or may also form a glued structure.

Specifically, with reference to FIG. 10, in an embodiment of the present disclosure, the lens 10 includes five lens elements 110. Each of the lens elements 110 includes a first sub-lens 111 and two second sub-lenses 112. The first sub-lens 111 and the second sub-lenses 112 in the same lens element may be sliced from a complete lens. The shape and the spacing direction relative to the incident axis 101 of the sub-lenses may refer to the embodiment shown in FIG. 1. The lens 10 further includes a first aperture 121 and second apertures 122. The first aperture 121 is in correspondence to each of the first sub-lenses 111, and the second apertures 122 are in correspondence to each of the second sub-lenses 112. In the direction parallel to the incident axis 101, an overlap exists between the projections of the first sub-lenses 111 and the first aperture 121 on the imaging surface 103, and an overlap exists between the projections of the second sub-lenses 112 and the second aperture 122 belonging to a same second imaging unit 1022. The first aperture 121 may be arranged between the first sub-lens 111 closest to the image side and the image sensor 210, or the first aperture 121 may also be arranged between any two first sub-lenses 111, or may be arranged on the object side of the first sub-lens 111 furthest from the image sensor 210, and the second aperture 122 is arranged in a similar manner. In these embodiments, the second imaging units should be central symmetric relative to the incident axis 101, so as to ensure that the brightness, the depth of field, and the size of the corresponding second images 106 tend to be the same.

The incident beam, after being adjusted by the first imaging unit 1021, will form a first image 105 on the imaging surface 103, and the incident beam, after being adjusted by the second imaging unit 1022, will form a second image 106 on the imaging surface 103. The spacing direction between the first image 105 and the second image 106 depends on the spacing direction between the first imaging unit 1021 and the second imaging unit 1022, and also depends on the arrangement positions of the first aperture 121 and the second aperture 122. The spacing distance between the first image 105 and the second image 106 depends on the spacing distance between the first imaging unit 1021 and the second imaging unit 1022, and also depends on the arrangement positions of the first aperture 121 and the second aperture 122.

In addition, in some embodiments, the first imaging unit 1021 and the second imaging unit 1022 may also be disposed inclined to the incident axis 101, i.e., the axis directions of the first imaging unit 1021 and the second imaging unit 1022 are inclined to the incident axis 101. At this time, the sub-lenses in the imaging unit located on the object side are closer to the incident axis 101 than the sub-lenses located on the image side.

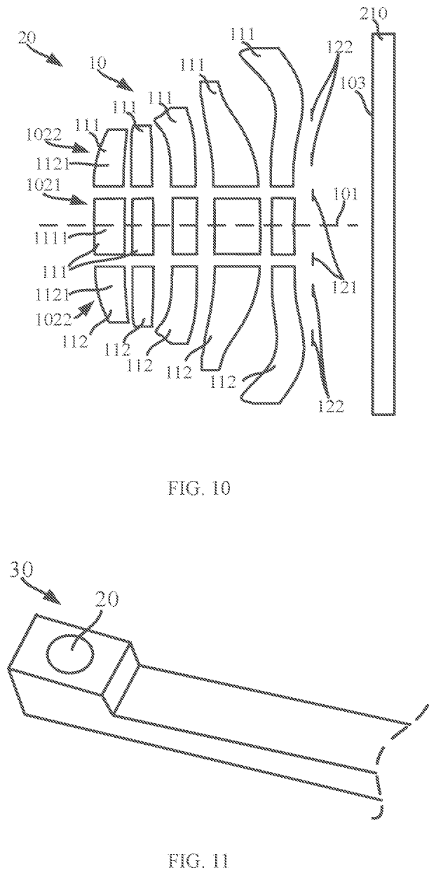

Referring to FIG. 11, an embodiment of the present disclosure also provide a three-dimensional imaging apparatus 30, and the three-dimensional imaging apparatus 30 may include the three-dimensional imaging module 20 in any embodiment. The three-dimensional imaging apparatus 30 may be applied in medical, industrial manufacturing, and other applications. Due to the small lateral size of the adopted aforementioned three-dimensional imaging module 20, the three-dimensional imaging apparatus 30 can perform efficient and flexible three-dimensional detection in narrow spaces. For example, when the three-dimensional imaging module 20 is disposed in the probe of the apparatus, the small size characteristic of the module can make the size of the probe smaller, thus improving the operational flexibility of the probe in narrow spaces. On the other hand, the aforementioned three-dimensional imaging module 20 can obtain two-dimensional information images and three-dimensional information images of the same region of the object being photographed, so it can effectively improve the merging of images at two adjacent scanning moments by the apparatus during continuous three-dimensional scanning, and improve the efficiency, accuracy and stability of continuous scanning.

In some embodiments, the three-dimensional imaging apparatus 30 includes, but is not limited to, smart phones, dental camera apparatus, industrial inspection apparatus, unmanned aerial vehicles, on-board camera apparatus, etc.

Some embodiments of the present disclosure further provide a three-dimensional imaging method, and the three-dimensional imaging method can be performed with the lens of the aforementioned embodiments. The three-dimensional imaging method in the embodiment of the present disclosure can perform excellent three-dimensional imaging of the object being photographed. And when the object being photographed is scanned continuously to acquire an overall three-dimensional model of the continuously scanned region, the accuracy of the three-dimensional model formed when the system performs continuous three-dimensional scanning on the object being photographed can be increased.

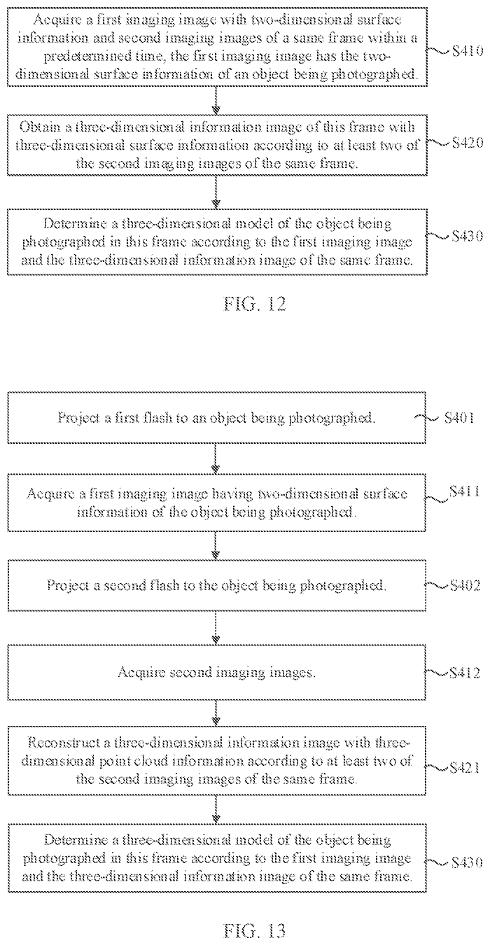

Referring to FIG. 12, in some embodiments, the three-dimensional imaging method includes the following steps:
in step S410, a first image and second images of a same frame are acquired within a predetermined time, and the first image has two-dimensional surface information of the object being photographed;
in step S420, a three-dimensional information image of this frame with three-dimensional surface information is obtained according to at least two of the second imaging images of the same frame; and
in step S430, a three-dimensional model of the object being photographed in this frame is determined according to the first image and the three-dimensional information image of the same frame.

The first image may be obtained through a first sub-lens in the lens element and the second images may be obtained through second sub-lenses in the lens element. Each of the second images has a one-to-one correspondence with each of the second sub-lenses in any one of the lens elements.

The image obtained during a shortest imaging period from the object being photographed can be considered as one frame. Each frame includes at least one first image and at least two second images. The total duration of the acquisition of the first image and the second images in a same frame should be avoided to be too long, so as to prevent the first image and the second images from cannot be the imaging of a same region of the object being photographed due to that the total duration of the acquisition of the two kinds of imaging images is too long. Generally, since three-dimensional imaging of the object being photographed often requires moving the lens to achieve the effect of continuous scanning, the imaging of each frame should be controlled to be within a very short time, thus ensuring that the imaging image of this frame is the imaging of a same region of the object being photographed.

In some embodiments, the predetermined time in step S410 can also be controlled to be within 200 ins. The predetermined time may specifically be 50 ms, 70 ms, 100 ms, 130 ms, 150 ms, 180 ms, or 200 ns. By keeping the total acquisition duration of the first image and the second images in one same frame within 200 ms, it is further ensured that the first image and the second images in the same frame are imaging of one same region of the object being photographed. As above, the first image and the second images of a same frame is acquired within a predetermined time can be understood as that, the time from the beginning of the exposure of the first imaging image to the end of the exposure of the last imaging image of a same frame is controlled within a predetermined time. It should be noted that, the first image and the second images of a same frame may or may not be acquired at the same time, and the order of acquisition of the two kinds of images is arbitrary, but the second images in a same frame should be acquired at the same time to ensure the accuracy of the three-dimensional information image obtained by step S420.

In particular, in some embodiments, in order to prevent the first image and the second images from mutual interference on imaging when acquiring the first image and the second images, for example, the first image is the imaging of full wavelength visible light, and the second images are the imaging of monochromatic visible light. The first image and the second images may be acquired separately with a short interval time therebetween, so as to avoid the mutual interference on imaging. In some embodiments, the interval time between acquiring the first image and acquiring the second images in a same frame meets the requirement of 0<t≤1 ms. For example, the aforementioned interval time can be understood as the interval time from the end of the exposure of the first image to the start of the exposure of the second images in a same frame. The order of exposure of the first image and the second images can be swapped. At this time, as the interval time is very short, the first image and the second images of a same frame are acquired sequentially or simultaneously within the very short interval time, such that the first image and the second images of the same frame can be regarded as the imaging of a same region of the object being photographed, and thus the three-dimensional model of this region of the object being photographed can be accurately represented.

On the other hand, in some embodiments, the exposure times of both the first image and the second images are controlled to be within 100 ms, thus also preventing the first image and the second image from cannot be the imaging of a same region of the object being photographed due to that the exposure times of the imaging images are too long.

As above, the three-dimensional imaging method may acquire a first image through the first sub-lens in the aforementioned lens and may acquire a second images through the second sub-lenses in the aforementioned lens. The first image has two-dimensional surface information (such as at least one of a color, a texture, a degree of light and a darkness, etc.) of the object being photographed, such that the first image can be a two-dimensional information image with two-dimensional surface information. A three-dimensional information image with three-dimensional surface information (such as depressions, bumps, etc.) is obtained by using at least two second images spaced from each other. Each frame of image has both two-dimensional and three-dimensional information. By combining the two-dimensional information image and the three-dimensional information image in the system, for example, superimposing the three-dimensional information image onto the two-dimensional information image, both two-dimensional information and three-dimensional information of the object being photographed are reflected in the final three-dimensional model, thereby effectively improving the accuracy of three-dimensional imaging for each frame. On the other hand, the first sub-lens and the second sub-lenses are installed in one lens, such that the three-dimensional imaging of the object being photographed can be achieved through one lens, which can greatly reduce the lateral size of the three-dimensional imaging system, such that the aforementioned three-dimensional imaging method can be flexibly and efficiently applied in narrow spaces.

In some embodiments, there are various methods for obtaining the three-dimensional information image by processing the second images at a certain angle and spaced apart from each other. Common methods of computing the second images to obtain depth information of the object being photographed by using the binocular disparity principle can be considered to be within the scope of the present disclosure.

Specifically, in some embodiments, image processing such as cross-correlation, least square method, etc. may be performed on the second images of a same frame to compare the second images, to obtain a dense three-dimensional point cloud of the corresponding imaging region of the object being photographed of this frame, and the depth information of the object may be reflected by the three-dimensional point cloud. Therefore, in some embodiments, after the step of acquiring the second images, the step S420 may specifically include: reconstructing the three-dimensional information image with the three-dimensional point cloud information from at least two second images of the same frame, to obtain the three-dimensional information image of this frame with the three-dimensional point cloud information. According to the three-dimensional point cloud information, three-dimensional topography of the surface of the object such as depressions and bumps can be determined.

In another aspect, there are various ways to obtain the first image and the second images. In some embodiments, the ambient light reflected by the object being photographed can be used to form the first image. That is, the ambient light irradiates the object being photographed and is then reflected into the lens, and after being converged by the first sub-lens, the first image is finally formed on the image sensor on the image side of the lens. The ambient light is generally white light such as sunlight or lamplight. At this time, the first image will have two-dimensional information such as color, texture, degree of light and darkness, etc. of the object being photographed. In some other embodiments, the object being photographed may also be irradiated with specific light to obtain the first image. Referring to FIG. 13, in some embodiments, when the step S410 is performed, the three-dimensional imaging method further includes step S401, projecting a first flash on the object being photographed, to form the first image by light reflected by the object being photographed to the lens. The first flash can be white light or monochromatic light. When the first flash is white light, the first image formed will carry information of the color, the texture, the degree of light and darkness, etc. of the object being photographed. When the first flash is monochromatic light, the first image formed will mainly carry information of the texture and the degree of light and darkness of the object being photographed.

Similarly, in some embodiments, the ambient light reflected by the object being photographed can also be used to form the second images. That is, the ambient light is irradiated to the object being photographed and is then reflected into the lens, and after being converged by each of the second sub-lenses, the second images, the number of which is the same as the number of the second sub-lenses in the lens element, are finally formed. At this time, the three-dimensional information image can be obtained by computing and analyzing at least two of the second images. It should be noted that, in some embodiments, when the first image and the second image are imaging for white light, there may be an overlapping exposure time of the first image and the second image without the need for separate acquisition. That is, when the imaging wavelength band of one of the first image and the second image (light wavelength permitting the formation of the corresponding imaging image) is included in or similar to the imaging wavelength band of the other, the first image and the second image may be acquired simultaneously, or there may be an overlapping exposure time of them, or they may be acquired separately. When the imaging wavelength band of one of the first image and the second images is included in the imaging wavelength band of the other, the corresponding filters may be disposed on the incident optical paths corresponding to the first image and the second images to prevent the imaging of the first image and the imaging of the second image from interfering with each other.

For example, in some embodiments, the first image corresponds to all light in the visible light region (400 nm-780 nm). That is, the first image may be a colored image, and the second image corresponds only to red light of 700 nm in the visible light region. At this time, an infrared cut-off filter can be disposed on the incident optical path corresponding to the first image to filter out infrared light, and a 700 nm narrow band pass filters can be disposed on the incident optical path corresponding to each of the second images to filter out incident light outside 700 nm. Thus, in these embodiments, when a white flash is projected on the object being photographed, due to the presence of the filters, the finally formed first image is a colored image and the second image is a red image at 700 nm, and the two do not interfere with each other. When the first image and the second image can be formed by the same kind of flash, the flash projected to the object being photographed can be illuminated continuously and continued until the end of the operation of the three-dimensional imaging.

According to the above it can be known that, in some embodiments, the first image and the second images can be obtained simultaneously by a single flash, such that the steps of three-dimensional imaging can be simplified.

In another aspect, referring to FIG. 13, in some embodiments, the three-dimensional imaging method further includes step S402, projecting a second flash on the object being photographed. The second images are acquired by receiving the second flash reflected by the object being photographed. The second flash can be white light or monochromatic light, such as visible or infrared light at a certain wavelength.

When it is necessary to enhance the imaging brightness of the second images, it can be realized by increasing the illumination brightness of the second flash. At this time, in order to avoid the second flash from interfering with the first image, the first flash and the second flash can be alternately projected to obtain the first image and the second image separately. For example, the first image is colored (400 nm-780 nm) imaging and the second image is red light (700 nm) imaging. At this time, white light may be projected on the object being photographed first to acquire the first image, and after the exposure is finished, red light of 700 nm with high brightness may be projected on the object being photographed to acquire the second images of the same frame, thereby preventing the red light with high brightness from interfering with the imaging of the white light.

When acquiring the images of a same frame, in some embodiments, the projection time of the first flash may be the same as the exposure time of the first image, the projection time of the second flash may be the same as the exposure time of the second imaging image, and the projection interval between the first flash and the second flash is also within the interval time. When it is necessary to acquire the first image and the second image of the next frame, a new projection period is performed to project the first flash and the second flash.

As above, referring to FIG. 13, in some embodiments, the step S410 includes the following steps:
in step S401, a first flash is projected to the object being photographed;
in step S411, a first image having two-dimensional surface information of the object being photographed is acquire,
in step S402, a second flash is projected to the object being photographed; and
in step S412, second images are acquired.

After obtaining the second images, the three-dimensional imaging method includes:
in step S421, a three-dimensional information image with three-dimensional point cloud information is reconstructed according to at least two of the second images of a same frame; and
in step S430, a three-dimensional model of the object to be photographed in the frame is determined according to the first image and the three-dimensional information image of the same frame.

In the aforementioned embodiment, when the first image and the second images of the same frame are acquired correspondingly, the first flash and the second flash are projected within a predetermined time, and the first image and the second images of the same frame are acquired within a predetermined time.

In some embodiments, the step S430 specifically includes: superimposing the two-dimensional surface information in the first image of the same frame with three-dimensional surface information in the three-dimensional information image to determine a three-dimensional model of the object being photographed in this frame. Thus, the two-dimensional information and three-dimensional information of the surface of the object being photographed can be presented simultaneously in the superposed three-dimensional model.

In another aspect, in some embodiments, the aforementioned three-dimensional imaging method can also be applied to the continuous three-dimensional scanning process of the object being photographed, and referring to FIG. 14, the three-dimensional imaging method further includes:
in step S442, three-dimensional information images of two adjacent frames are acquired;
in step S444, a feature matching process is performed on the three-dimensional information images of the two adjacent frames to obtain a point cloud matching result; and
in step S446, the three-dimensional information images of the two adjacent frames are merged according to the point cloud matching result.

In the aforementioned Step S442, a three-dimensional information image of this frame is obtained by processing at least two of the second images of each of the two adjacent frames. The step of obtaining a three-dimensional information image of each frame according to at least two of the second images of this frame may be as follows: reconstructing a three-dimensional information image with a three-dimensional point cloud according to at least two of the second images of the same frame. In this step, the dense three-dimensional point cloud of the corresponding imaging region of the object being photographed of the frame can be reconstructed by performing image process, such as cross-correlation, least square method, etc., on at least two of the second images of the same frame. The three-dimensional point cloud in three-dimensional information image can reflect the depth information of the object.

In the aforementioned step S444, by performing the iterative closest point (ICP) algorithm process on the three-dimensional information images of the adjacent frames, the matching of the three-dimensional point clouds in the three-dimensional information images of the two adjacent frames can be realized, so as to obtain the point cloud matching result. Then step S446 is performed. The three-dimensional information images of the two adjacent frames are merged according to the point cloud matching result, and the continuous three-dimensional model of the object being photographed is finally reconstructed.

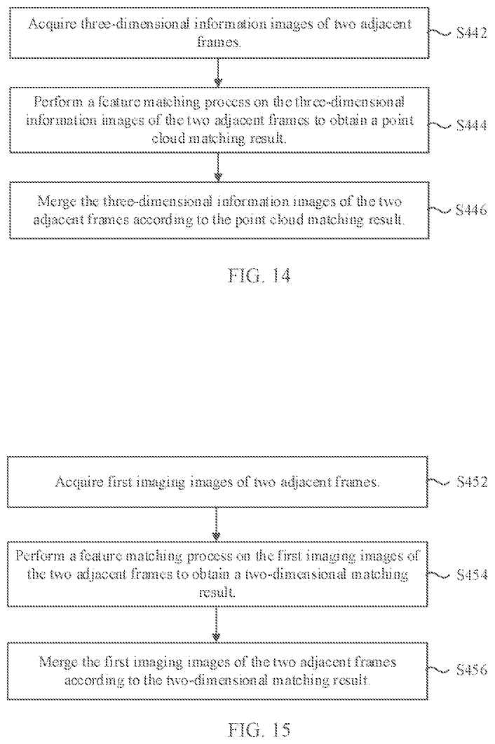

In addition to using the three-dimensional information in the three-dimensional information image for merging, the two-dimensional information in the first images can be combined and used for merging, the two merging processes can be mutually assisted in correcting, which can greatly improve the accuracy and completeness of the continuous three-dimensional model. Thus, referring to FIG. 15, in some embodiments, the three-dimensional imaging method includes:
in step S452, the first images of two adjacent frames are acquired;
in step S454, a feature matching process is performed on the first images of the two adjacent frames to obtain a two-dimensional matching result, and
in step S456, the first images of the two adjacent frames are merged according to the two-dimensional matching result.

In the aforementioned step S454, the step of performing the feature matching process on the first images of the adjacent frames includes any one of the following:
a scale-invariant feature transform (SIFT) process is performed on corresponding features in the first images of the two adjacent frames; or
a speeded up robust feature (SURF) process is performed on corresponding features in the first images of the two adjacent frames; or
a process of recovering structure from motion (SFM) method is performed on corresponding features in the first images of the two adjacent frames.

Through the aforementioned feature matching processing method, the first images of adjacent frames are calculated by feature algorithm. If the feature points (such as extremum points) in the adjacent frame images can be obtained, information such as the position and direction value (gradient value) of the feature points can be obtained, and the information such as the positions and directional values (gradient value) of the corresponding feature points in the first images of the adjacent frames can be compared to obtain the moving distance, the moving direction, the rotation angle and other information of the images of the adjacent frames. The step S456 is then performed through these matching results to merge the first images of the adjacent frames to obtain a continuous two-dimensional information image corresponding to the scanning region. It is to be noted that, with respect to steps S442, S444, and S446, and steps S452, S454, and S456, after obtaining the corresponding first image and three-dimensional information image, the two kinds of steps may be executed successively or simultaneously.

Therefore, according to the merging information of the first images and the merging information of the three-dimensional information images, the continuous three-dimensional model of the object being photographed can be reconstructed more stably and accurately. In some embodiments, the final continuous three-dimensional model may be only a merged continuous three-dimensional information image, and the merging process of the first images is used to assist in correcting the merging of the three-dimensional information images. In some other embodiments, by combining the merging processes of the first images and the three-dimensional information images, the continuous two-dimensional information image and the three-dimensional information image are superposed to obtain the three-dimensional model of the scanning region with two-dimensional information (color, texture, degree of light and darkness, etc.) and three-dimensional information (depression, bump, etc.).

As above, in some environments, the geometric characteristics of the surface of the object are not obvious, resulting in too little effective information in the three-dimensional information image, and it is difficult to play a good merging role in the continuous scanning process. The above merging process of the first images with two-dimensional surface information can focus on using the matching processing of two-dimensional information to achieve merging of the imaging of adjacent frames at the two-dimensional information level, thereby effectively improving the accuracy and stability of the scanning of objects with insignificant geometric characteristics.

By combining the aforementioned merging processes of the first images and the three-dimensional information images, a stable and accurate three-dimensional model can be obtained during the continuous scanning on the object being photographed by the three-dimensional imaging method in the embodiment of the present disclosure.

In particular, in the case that the geometric characteristics of the surface of the object being photographed are not obvious, the three-dimensional imaging method may mainly rely on computing the two-dimensional information of the first images of the adjacent frames to realize image merging in the continuous scanning process. When the color, texture and other two-dimensional information of the surface of the object being photographed are not obvious, the three-dimensional imaging method can mainly rely on computing the three-dimensional information images of adjacent frames to realize the image merging in the continuous scanning process. Therefore, the aforementioned three-dimensional imaging method can be applied to a variety of scenes, and has stable and reliable continuous scanning performance. On the other hand, the first sub-lens and the second sub-lenses are installed in one lens, such that the three-dimensional imaging of the object being photographed can be achieved through one lens, which can greatly reduce the lateral size of the three-dimensional imaging system, such that the aforementioned three-dimensional imaging method can be flexibly and efficiently applied in narrow spaces.

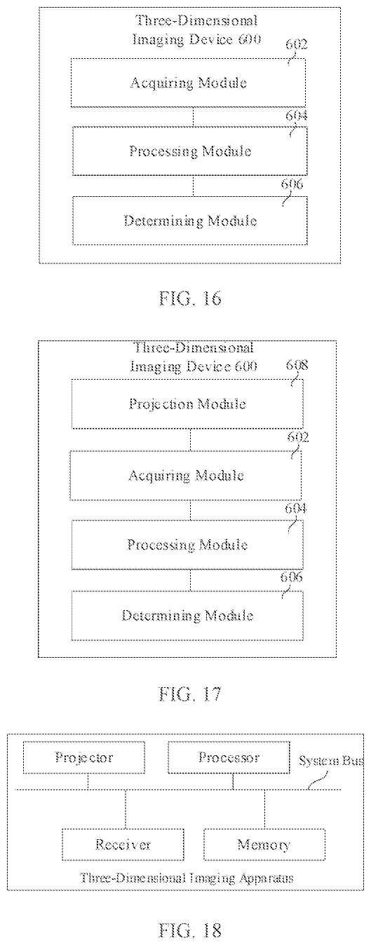

Referring to FIG. 16, some embodiments of the present disclosure further provide a three-dimensional imaging device 600, which includes.
an acquiring module 602, configured to acquire a first image and second images of a same frame within a predetermined time, wherein the first image has two-dimensional surface information of the object,
a processing module 604, configured to obtain, according to at least two of the second images of the same frame, a three-dimensional information image of this frame having three-dimensional point cloud information; and
a determining module 606, configured to determine, according to the first image and the three-dimensional information image of the same frame, a three-dimensional model of the object being photographed in this frame.

Referring to FIG. 17, in some embodiments, the three-dimensional imaging device 600 further includes a projection module 608 configured to project a first flash and a second flash to the object being photographed within a predetermined time, and the acquiring module 602 is configured to acquire the first image according to the first flash and is configured to acquire the second images according to the second flash.

The specific definition of each of the modules of the three-dimensional imaging device 600 may refer to the definition of the three-dimensional imaging method above, and will not be described here. Each of the modules of the aforementioned three-dimensional imaging device 600 can be realized in whole or in part by software, hardware and their combination. The aforementioned modules can be hardwares embedded in or independent of the processor in the three-dimensional imaging apparatus, or softwares stored in memory in the three-dimensional imaging apparatus, such that the processor can call and perform the corresponding operations of the above modules.

For example, in some embodiments, the aforementioned acquiring module 602 in terms of hardwares includes the lens described in any one of the above embodiments and an image sensor provided on the image side of the lens, and the incident light is adjusted by the first sub-lens and the second sub-lenses in the lens to form the first image and the second images on the photosensitive surface of the image sensor, respectively.

Referring to FIG. 18, some embodiments of the present disclosure further provide a three-dimensional imaging device 600, which includes:
a projector, configured to project a first flash and a second flash to an object within a predetermined time,
a memory, configured to store a computer program;
a receiver, configured to acquire a first image according to the first flash and second images according to the second flash within a predetermined time, wherein the first image has two-dimensional surface information of the object being photographed.
a processor, configured to execute the computer program on the memory to implement: obtaining a three-dimensional information image of this frame with three-dimensional point cloud information according to at least two of the second images of the same frame; and determining a three-dimensional model of the object being photographed in this frame according to the first image and the three-dimensional information image of the same frame.

The projector, the receiver, the memory, and the processor are connected by a system bus.

In some embodiments, the definition of the projector may refer to the definition of the three-dimensional imaging method above, which is not described here. For example, in some embodiments, the projector is capable of sequentially projecting a first flash and a second flash to the object within a predetermined time. For the projector, in some embodiments, the projector may be a light source capable of projecting flashes, specifically but not limited to a laser light source or an LED light source.

In some embodiments, the receiver includes the lens described in any one of the above embodiments and an image sensor disposed on the image side of the lens. The first flash is adjusted by a first sub-lens in the lens to form a first image on a photosensitive surface of the image sensor, and the second flash is adjusted by second sub-lenses to form second images on the photosensitive surface of the image sensor. The image sensor is capable of transmitting the signals of the first image and the second images to the processor.

In some embodiments, the definition of the processor may refer to the definition of the three-dimensional imaging method above, which is not described here. As above, a computer program is stored in the memory, and the processor, when executing the computer program, can implement the steps in the various method embodiments described above.

It is understood by those skilled in the art that the structure shown in FIG. 18 is only a block diagram of a part of the structure related to the solutions of the present disclosure, and does not constitute a limitation on the three-dimensional imaging apparatus to which the solutions of the present disclosure are applied. The specific three-dimensional imaging apparatus may include more or fewer components than those shown in the figure, or may combine certain components, or may have different component arrangements.

In an embodiment, a computer readable storage medium is provided. The computer readable storage medium stores a computer program that, when executed by a processor, implements the steps in the various method embodiments described above.

Those skilled in the art can understand that the implementation of all or part of the processes of the aforementioned embodiment methods can be accomplished by instructing relevant hardware through a computer program stored in a non-volatile computer readable storage medium, and the computer program when executed may include the processes of the embodiments of the aforementioned methods. Any reference to memory, storage, database or other media used in the embodiments provided by the present disclosure may include at least one of non-volatile and volatile memory. Non-volatile memory may include read-only memory (ROM) magnetic tape, floppy disk, flash memory, or optical memory. Volatile memory may include Random Access Memory (RAM) or external cache memory. By way of illustration rather than limitation, RAMs can take many forms, such as static random access memory (SRAM) or dynamic random access memory (DRAM).

In the aforementioned three-dimensional imaging method, three-dimensional imaging device 600, three-dimensional imaging apparatus and storage medium, the first image with the two-dimensional information of the surface of the object being photographed and the three-dimensional information image with the three-dimensional information of the surface of the object being photographed are used to determine the three-dimensional model of the surface of the object, so as to effectively improve the accuracy of three-dimensional imaging of each frame. And further, the aforementioned three-dimensional imaging method, three-dimensional imaging device 600, three-dimensional imaging apparatus and storage medium can also be applied to continuous three-dimensional scanning. The continuous scanning of the object being photographed can obtain a stable and accurate continuous three-dimensional model by combining the aforementioned merging processes of the first images and the three-dimensional information images.

In the description of the present disclosure, it is necessary to understand that the terms “center,” “longitudinal,” “lateral,” “length,” “width,” “thickness,” “up,” “down,” “front,” “back,” “left,” “right,” “vertical,” “horizontal,” “top,” “bottom,” “inner,” “outer,” “clockwise,” “anti-clockwise,” “axial,” “radial,” “circumferential” and other indicated directional or positional relationship are based on the directional or positional relationship shown in the drawings, they are only for the purpose of describing the invention and simplifying the description, and are not indicative or implied that the device or element must have a specific direction or be constructed and operated with a specific direction, and therefore cannot be understood as a limitation of the present disclosure.

In addition, the terms “first” and “second” are used for descriptive purposes only and cannot be understood as indicating or implying relative importance or an implied indication of the number of technical features indicated. Thus, a feature defined as “first” or “second” may expressly or implicitly include at least one such feature. In the description of the present disclosure, “plurality” means at least two, such as two, three, etc., unless otherwise specifically defined.

In the present disclosure, unless otherwise clearly stipulated and defined, the terms “installation,” “connected,” “connection,” “fixing” and other terms shall be broadly understood, for example, may be fixed connection, or may be removable connection, or may be integrated; may be mechanical connection, or electrical connection; may be directly connected or indirectly connected through an intermediate medium, and may be a communication within two elements or an interaction between two elements, unless otherwise expressly defined. For those ordinary skilled in the art, the specific meanings of the above terms in the present disclosure can be understood according to the specific circumstances.

In the present disclosure, unless otherwise expressly provided and defined, when the first feature is “on” or “under” the second feature, the first feature may be in direct contact with the second feature, or the first feature may be in indirect contact with the second feature through an intermediate medium. Further, when the first feature is “above,” “on” and “on the top of” the second feature, the first feature may be directly above or obliquely above the second feature, or may simply indicate that the first feature is higher in level than the second feature. Further, when the first feature is “below” ““under” or “on the bottom of” the second feature, the first feature may be directly below or obliquely below the second feature, or may simply indicate that the first feature is lower in level than the second feature.

In the description of this specification, the description of the terms “one embodiment,” “some embodiments,” “examples,” “specific examples,” or “some examples,” among others, refers to specific features, structures, materials, or features described in connection with this embodiment or example contained in at least one embodiment or example of the present disclosure. In this specification, the illustrative expression of the aforementioned terms need not be directed to the same embodiments or examples. Moreover, the particular features, structures, materials or features described may be combined in a suitable manner in any one or more embodiments or examples. In addition, without contradiction, those skilled in the art may combine and assembly with the features of the different embodiments or examples described in this specification and the different embodiments or examples.

The technical features of the above-described embodiments may be arbitrarily combined, and in order to make the description concise, all possible combinations of the technical features in the above-described embodiments are not described. However, as long as there is no contradiction in the combination of these technical features, it should be considered as the scope of this specification.

The embodiments described above express only a few embodiments of the present disclosure, which are described more specifically and in more detail, but are not thereby understood as limiting the scope of the invention patent. It should be noted that, for those ordinary skilled in the art, a plurality of modifications and improvements may be made without departing from the concept of the present disclosure, which all fall within the protection scope of the present disclosure. Therefore, the protection scope of the invention patent shall be subject to the attached claims.

1. A lens having an incident axis and a lens element, wherein the lens element comprising:
a first sub-lens, the first sub-lens comprising a first effective light passing portion; and
at least two second sub-lenses, each of the second sub-lenses having a non-rotationally symmetric structure, each of the second sub-lenses comprising a second effective light passing portion, and the second effective light passing portions of any two of the second sub-lenses being rotationally symmetric relative to the incident axis;
wherein the first sub-lens and the at least two second sub-lenses in the lens element are capable of being spliced together to form a complete lens rotationally symmetric relative to an optical axis; and
wherein the first effective light passing portion of the lens element is configured for an incident beam to pass therethrough to form a first image on an image side of the lens; the second effective light passing portions in the lens element are configured for the incident beam to pass therethrough to form second images on the image side of the lens, the number of the second images is the same as the number of the second effective light passing portions, and the first image and the second images are spaced apart from each other.

2. The lens according to claim 1, wherein a shape of a projection of the formed complete lens on a plane perpendicular to the incident axis is circular.

3. The lens according to claim 1, wherein the first sub-lens and the second sub-lenses in the lens element are spaced apart or staggered in a direction perpendicular to the incident axis.

4. The lens according to claim 1, further comprising a plurality of lens elements, the plurality of lens elements being divided into a first imaging unit and at least two second imaging units, wherein the first imaging unit comprises a plurality of first sub-lenses arranged in a direction parallel to the incident axis, each of the second imaging units comprises a plurality of second sub-lenses arranged in a direction parallel to the incident axis, the number of the first sub-lenses in the first imaging unit is equal to the number of the second sub-lenses of any of the second imaging units, each of the first sub-lenses is contained in one of the lens elements, and each of the second sub-lenses of each of the second imaging units is contained in one of the lens elements.

5. The lens according to claim 1, further comprising a first aperture and at least two second apertures, wherein the number of the second apertures is equal to the number of the second sub-lenses in the lens element, in a direction parallel to the incident axis, an overlap exists between a projection of the first sub-lens in the lens element and a projection of the first aperture on a plane perpendicular to the incident axis, and an overlap exists between a projection of each of the second sub-lenses in the lens element and a projection of one of the second apertures on a plane perpendicular to the incident axis.

6. The lens according to claim 8, wherein an aperture diameter of the first aperture is larger than an aperture diameter of each of the second apertures.

7. A three-dimensional imaging module comprising an image sensor and the lens according to claim 1, wherein the image sensor is provided on the image side of the lens.

8. The three-dimensional imaging module according to claim 7, further comprising a first filter and at least two second filters, wherein an overlap exists between a projection of the first filter and a projection of the first sub-lens in the lens element on a plane perpendicular to the incident axis, an overlap exists between a projection of each of the second sub-lenses in the lens element and a projection of one of the second filters on a plane perpendicular to the incident axis, and wavelength of light filtered out by the first filter is different from wavelength of light filtered out by each of the second filter.

9. A three-dimensional imaging apparatus comprising the three-dimensional imaging module according to claim 7.

10. The three-dimensional imaging apparatus according to claim 9, further comprising a light source which is fixedly disposed relative to the lens, wherein the light source is configured to irradiate an object being photographed.

11. A three-dimensional imaging method, applied to the lens according to claim 1, the three-dimensional imaging method comprising:
acquiring a first image and second images of a same frame within a predetermined time, wherein the first image includes two-dimensional surface information of an object being photographed;
acquiring, according to at least two of the second images of the same frame, a three-dimensional information image of this frame, wherein the three-dimensional information image includes three-dimensional point cloud information; and
determining, according to the first image and the three-dimensional information image of the same frame, a three-dimensional model of the object being photographed of this frame.

12-19. (canceled)

20. A three-dimensional imaging apparatus, comprising:
a projector configured to project a first flash and a second flash to an object being photographed within a predetermined time;
a memory, configured to store a computer program;
a receiver configured to acquire a first image according to the first flash and second images according to the second flash within a predetermined time, wherein the first image has two-dimensional surface information of the object being photographed; and
a processor configured to execute the computer program on the memory to implement: obtaining a three-dimensional information image of this frame with three-dimensional point cloud information according to at least two of the second images of the same frame; and determining a three-dimensional model of the object being photographed in this frame according to the first image and the three-dimensional information image of the same frame.

21. (canceled)

22. A storage medium on which a computer program is stored, wherein the computer program, when executed by a processor, implements the steps of the method according to claim 11.

23. The lens according to claim 1, wherein the lens meets any one of the following options:
the lens element comprises one first sub-lens and two second sub-lenses, in a direction parallel to the incident axis, projection of the one first sub-lens is sandwiched between projections of the two second sub-lenses; and
the lens element comprises one first sub-lens and three second sub-lenses, in a direction parallel to the incident axis, shapes of projections of the one first sub-lens and the three second sub-lenses on a plane perpendicular to the incident axis are fan shaped.

24. The lens according to claim 1, wherein any two of the second sub-lenses of the lens element are rotationally symmetric relative to the incident axis.

25. The lens according to claim 1, wherein an axial direction of each of the second sub-lenses is inclined to the incident axis.

26. The lens according to claim 8, wherein a central axis of each of the second apertures is inclined to the incident axis.

27. The lens according to claim 8, wherein the number of the second apertures and the number of the second sub-lenses of the lens element are both two, and a line connecting centers of the two second apertures is inclined to a line connecting centers of gravity of the two second sub-lenses.

28. The lens according to claim 1, further comprising a lens barrel, wherein the lens element is arranged in the lens barrel, an object end of the lens barrel is defined with a light inlet aperture, and a central axis of the light inlet aperture is coaxial with the incident axis of the lens.

29. The three-dimensional imaging module according to claim 13, wherein the image sensor is a CCD or a CMOS element.
